(19) United States
(12) Patent Application Publication
(10) Pub. No.: US 2007/0111084 A1
(43) Pub. Date: May 17, 2007

(54) Methanol tolerant catalyst material containing membrane electrode assemblies and fuel cells prepared therewith

(76) Inventors: Clarence G. Law, Newark, DE (US); Vitali Arkad'evich Grinberg, Moscow (RU); Tat'jana L'vovna Kulova, Moscow (RU); Alexander Mordukhaevich Skundin, Moscow (RU); Alexander Anatol'evich Pasynskii, Moscow (RU)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/245,269

(22) Filed: Oct. 5, 2005

Related U.S. Application Data
(60) Provisional application No. 60/616,233, filed on Oct. 6, 2004.

(30) Foreign Application Priority Data
Oct. 5, 2004 (RU) 2004129396

(51) Int. Cl. H01M 4/86; H01M 4/94; H01M 4/96; B05D 5/12; H01M 4/88

(52) U.S. Cl. 429/42; 429/44; 427/115; 427/113; 502/101

(57) ABSTRACT

Methanol tolerant catalyst material containing membrane electrode assemblies and fuel cells prepared therewith are provided. A substrate is coated with an electrocatalyst coating composition that includes a methanol tolerant catalyst obtained by mixing together: (1) organometallic clusters containing (i) a carbonyl group or a cyclic unsaturated hydrocarbon ligand group, and (ii) a chalcogen containing group selected from MₙFeₚXₘ, MₙXₘ, MₙClₚXₘ, or mixtures thereof wherein M=Pt, Ru or Re, X=S, Se or Te, and m, n and p=1 or 2, (2) an electrically conductive component, and (3) an organic solvent, such that the clusters are adsorbed on the electrically conductive component; subsequently removing the solvent; and in a non-oxidizing atmosphere, heat-treating of the clusters adsorbed on the electrically conductive component at a temperature of at least 175° C. These coated substrates make good materials for use in positive electrodes in direct methanol fuel cells because the catalysts are tolerant towards methanol action after methanol crossover.

### FIELD OF THE INVENTION

The present invention relates in general to catalysts useful for catalytic oxygen reduction reactions, and more particularly, to methanol tolerant electrocatalysts useful as cathode material for the electroreduction of oxygen in direct methanol fuel cells.

### BACKGROUND OF THE INVENTION

Based on rapidly expanding needs for power generation and the desire to reduce the use of hydrocarbon fuels as well as a reduction in polluting emissions, fuel cells are expected to fill an important role in applications such as transportation and utility power generation. Fuel cells are highly efficient devices producing very low emissions, have a potentially renewable fuel source, and convenient refueling. Fuel cells convert chemical energy to electrical energy through the oxidation of fuels such as hydrogen or methanol to form water and carbon dioxide. Hydrogen fuel, however, presents serious storage and transportation problems. For these reasons, significant attention has been paid to the development of liquid fuel based fuel cells, and more particularly, to fuel cells in which methanol is fed directly to the fuel cell without any pre-treatment, i.e., direct methanol fuel cells (DMFCs). Without the need of a chemical pre-processing stage, methanol fuel is fed directly to the fuel cell. Also, other bulky accessories are not needed. This simplicity in design and construction make DMFC suitable for many applications requiring portable power supplies.

Electrochemical fuel cells convert fuel and oxidant to electricity and reaction products. Fluid reactants are supplied to a pair of electrodes that are in contact with and separated by an electrolyte. The electrolyte may be a solid or a liquid, i.e., a supported liquid matrix. Solid electrolytes are comprised of solid ionomer or ion-exchange membrane disposed between two planar electrodes. The electrodes typically comprise an electrode substrate and an electrocatalyst layer disposed upon a major surface of the substrate. The electrode substrate typically comprises a sheet of porous, electrically conductive material, such as carbon cloth or carbon fiber paper. The electrode catalyst is typically in the form of finely comminuted metal, such as platinum, and is disposed on the surface of the electrode substrate in order to induce the desired electrochemical reaction. In a single cell, the electrodes are electronically coupled to provide a path for conducting electrons through an external load thereby producing electric current.

In a direct methanol fuel cell the reactions taking place at the anode, cathode, and the overall reaction are given below:

Anode Reactions:
(i) CH₃OH→COH_{ads}+3H_{ads}; (1)
(ii) anodic oxidation of adsorbed hydrogen:
3H_{ads}→3H⁺+3e; (2)
(iii) adsorption of some oxygen-containing species:
3H₂O→3OH_{ads}+3H⁺+3e; (3)
(iv) interaction of the adsorbed species and their removal from the surface:
COH_{ads}+3OH_{ads}→CO₂↑+2H₂O. (4)

The consecutive and parallel combination of the steps (ii)-(v) gives overall anode reaction:
CH₃OH+H₂O→CO₂↑+6H⁺+6e. (5)
Cathode Reaction:
O₂+4H⁺+4e→2H₂O
Overall Cell Reaction:
CH₃OH+1.5O₂→CO₂+2H₂O

The protons formed at the anode electrocatalyst migrate through the ion-exchange membrane from the anode to the cathode, while the electrons flow through an external load. At the cathode, the oxidant (oxygen) reacts with the protons to form water. In these fuel cells, crossover of a reactant from one electrode to the other is undesirable. Reactant crossover may occur if the electrolyte is permeable to the reactant (methanol), i.e., some of the reactant introduced at a first electrode of the fuel cell may pass through the electrolyte to the second electrode, instead of reacting at the first electrode. Reactant crossover typically causes a decrease in both reactant utilization efficiency and fuel cell performance. Fuel cell performance is defined by the voltage vs current polarization curve. The higher the voltage is at a given current density, the better the performance. Or, alternatively, the higher the current density is at a given voltage, the better the performance.

Fuel efficiency utilization losses arise from methanol transport away from the anode since some of the methanol which would otherwise participate in the oxidation reaction at the anode and supply electrons to do work through the external circuit is lost. Methanol arriving at the cathode has a deleterious effect as to decrease the Oxygen concentration at the cathode to form CO₂. However, in the likely event of incomplete reaction, CO is formed which acts further to poison the cathode surface. Furthermore, it has been well documented that for cathode electrocatalysts of the prior art, methanol oxidation poisons the catalytic activity of the electrocatalysts at the cathode. See, for example, Chu et al., J. Electrochem. Soc., Vol. 141, 1770-1773 (July 1994); Kuver et al., Electrochemica Acta, Vol. 43, 2527-2535 (1998); Cruickshank et al., J. Power Sources, Vol. 70, 40-47 (1998); and Kuver et al., J. Power Sources, Vol. 74, 211-218 (1998). Several prior art patents have focused on reducing reactant crossover in electrochemical fuel cells, generally through modifications of the electrolyte membrane or the anode electrode itself. See, for example, U.S. Pat. Nos. 5,672,438; 5,672,439; 5,874,182; 5,849,428; 5,945,231; and 5,919,583. However, it has generally been found that electrolyte membranes which reduce methanol crossover also reduce fuel cell performance in that ion transfer is reduced. Essentially, a tradeoff is being made. Moreover, none of these prior art patents deal with improvements to the cathode electrocatalyst material itself in order to make the catalyst methanol tolerant.

The state-of-the-art electrocatalysts used for the reduction of oxygen generally comprise platinum or platinum-metal alloys on a substrate of carbon powder or the like. See, for example, U.S. Pat. Nos. 4,316,944; 4,822,699; 4,264,685; and 5,876,867. In addition, metal-containing macrocyclic compounds have been investigated for a number of years as fuel cell catalysts. These metal macrocyclic compounds include N₄-chelate compounds, such as phthalocyanines, porphyrins, and tetraazaannulenes. See, for example, U.S. Pat. No. 5,316,990 and Faubert et al., Electrochemica Acta, Vol. 43, pp. 341-353, (1998). However, these catalysts have not proven to be methanol tolerant.

The systems on the basis of MoRuX where X=S, Se or Te also were suggested (V. Trapp. P. Christensen, A. Hamnett, J. Chem. Soc., Trans., 92(1996)4311, R. W. Reeve, P. Christensen, A. Hamnett et al, J. Electrochem. Soc., 145(1998)3463). The long-term stability of such cathodes is very low. In addition, the preparation of such material by pure catalytic methods is very difficult due to low reproducibility of described procedures.

In the article, Methanol-resistant cathodic oxygen reduction catalyst for methanol fuel cells, H. Tributsch, M. Bron, M. Hilgendorff et al J. Appl. Electrochem. 31 (2001) 739-748); results are presented for MoRuX and RuSe systems. These catalysts are colloidal ruthenium carbonyl complexes.

### SUMMARY OF THE INVENTION

The disclosure provides substrate coated with a methanol tolerant electrocatalyst, and a method of making the same, fulfilling the needs of direct methanol fuel cells. These novel coated substrates are excellent oxygen reduction materials while at the same time not causing methanol oxidation or being poisoned by the presence of methanol.

In a first aspect, the disclosure provides a coated substrate comprising a substrate having coated thereon an electrocatalyst coating composition, wherein the electrocatalyst coating composition comprises a methanol tolerant catalyst obtained by mixing together: (1) organometallic clusters containing (i) a carbonyl group or a cyclic unsaturated hydrocarbon ligand group, and (ii) a chalcogen containing group selected from MₙFeₚ, MₙXₘ, MₙClₚXₘ, or mixtures thereof wherein M=Pt, Ru or Re, X=S, Se or Te, and m, n and p=1 or 2, (2) an electrically conductive component, and (3) an organic solvent, such that the clusters are adsorbed on the electrically conductive component; subsequently removing the solvent; and in a non-oxidizing atmosphere, heat-treating of the clusters adsorbed on the electrically conductive component at a temperature of at least 175° C. In one embodiment, the electrically conductive component is chosen from particulate carbons such as carbon black, conducting polymers, conducting transition metal carbides, conducting metal oxide bronzes and other conducting carbons. These catalyst materials show a definite composition, long-term stability and high catalytic oxygen reduction activity. It is believed that these nanostructured electrocatalysts have di-facial configurations wherein the metal chalcogenide cluster performs the role of catalyst and the chalcogenides may also act as bridges to transfer electrons to catalyze reduction of the oxygen molecule. The substrate may be chosen from either a polyelectrolyte membrane or a gas diffusion backing.

In a second aspect, the disclosure provides a coated substrate comprising a substrate having coated thereon an electrocatalyst coating composition, wherein the electrocatalyst coating composition comprises a methanol tolerant catalyst comprising a heat-treated chalcogenide adsorbed onto an electrically conductive component, the chalcogenide including the group of MₙFeₚXₘ, MₙXₘ, MₙClₚXₘ, or mixtures thereof wherein M=Pt, Ru or Re, X=S, Se or Te, and m, n and p=1 or 2. The catalyst material comprises a di-facial nano-structured configuration. The substrate may be chosen from either a polyelectrolyte membrane or a gas diffusion backing.

In a third aspect, the disclosure also provides a method for producing a coated substrate comprising a substrate having coated thereon an electrocatalyst coating composition, including the steps of (a) mixing together: (1) organometallic clusters containing (i) a carbonyl group or a cyclic unsaturated hydrocarbon ligand group, and (ii) a chalcogen containing group selected from MₙFeₚ, MₙXₘ, MₙClₚXₘ, or mixtures thereof wherein M=Pt, Ru or Re, X=S, Se or Te, and m, n and p=1 or 2, (2) an electrically conductive component, and (3) an organic solvent, such that the clusters are adsorbed on the electrically conductive component; (b) removing the solvent; (c) in a non-oxidizing atmosphere, heat-treating the clusters adsorbed on the electrically conductive component at a temperature of at least 175° C., (d) mixing the heat-treated clusters adsorbed on the electrically conductive component with a binder to form an electrocatalyst coating composition, and (e) applying the electrocatalyst coating composition to the substrate.

In a fourth aspect, the disclosure provides a fuel cell comprising a coated substrate, wherein the coated substrate comprises a substrate having coated thereon an electrocatalyst coating composition, wherein the electrocatalyst coating composition comprises a methanol tolerant catalyst comprising a heat-treated chalcogenide adsorbed onto an electrically conductive component, the chalcogenide including the group of MₙFeₚXₘ, MₙXₘ, MₙClₚXₘ, or mixtures thereof wherein M=Pt, Ru or Re, X=S, Se or Te, and m, n and p=1 or 2. The substrate may be chosen from either a polyelectrolyte membrane or a gas diffusion backing.

### BRIEF DESCRIPTION OF THE DRAWINGS

FIG. 1 shows the chemical structure of the materials used for preparation of the electrocatalysts of the present invention.

FIG. 2A is a schematic representation of the electrocatalyst of the present invention interacting with an oxygen molecule.

FIG. 2B is a schematic representation of a proposed mechanism for catalytic oxygen reduction by the electrocatalysts of the present invention.

FIG. 3 is a graph showing fuel cell performance of catalyst Pt—S—N compared to a commercially available catalyst.

### DETAILED DESCRIPTION OF THE INVENTION

Catalyst:

The catalysts of the present invention are compositions of matter having a structure including catalytic active sites. These active sites may consist of at least two different kinds of metal atoms MFeX or MX where M=Pt, Ru, or Re, and X=S, Se, or Te. The catalytic compounds containing these active sites are distributed on or in conductive carbon, graphite nanostructures, or other suitable electrically conductive substrates or supports, hereafter referred to as an electrically conductive component. These new catalyst materials are very effective at catalyzing 4-electron oxygen reduction to water, while being completely inactive towards the oxidation of methanol.

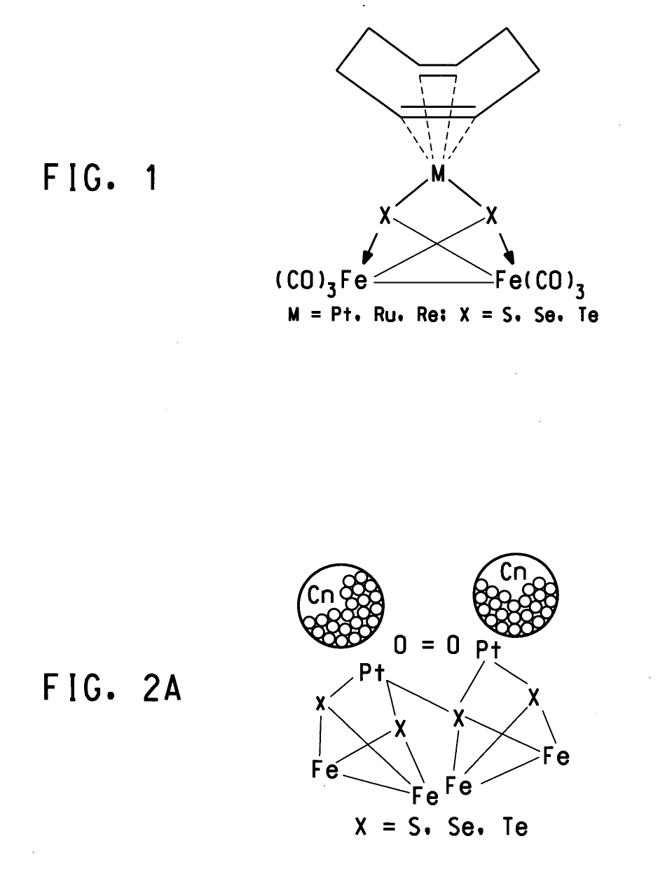

In one embodiment, the methanol tolerant catalyst material is obtained by mixing together: (1) organometallic clusters containing (i) a carbonyl group or a cyclic unsaturated hydrocarbon ligand group, and (ii) a chalcogen containing group selected from MₙFeₚXₘ, MₙXₘ, MₙClₚXₘ, or mixtures thereof wherein M=Pt, Ru or Re, X=S, Se or Te, and m, n and p=1 or 2, (2) an electrically conductive component, and (3) an organic solvent, such that the clusters are adsorbed on the electrically conductive component; subsequently removing the solvent; and in a non-oxidizing atmosphere, heat-treating the clusters adsorbed on the electrically conductive component at a temperature of at least 175° C. An example of the chemical structure of a starting material is shown in FIG. 1, where a metal-containing compound where M represents a precious metal selected from Pt, Ru and Re.

The catalyst material is produced by mixing together (1) organometallic clusters containing (i) a carbonyl group or a cyclic unsaturated hydrocarbon ligand group, and (ii) a chalcogen containing group selected from MₙFeₚ, MₙXₘ, MₙClₚXₘ, or mixtures thereof wherein M=Pt, Ru or Re, X=S, Se or Te, and m, n and p=1 or 2, (2) an electrically conductive component, and (3) an organic solvent, such that the clusters are adsorbed on the electrically conductive component. The electrically conductive component preferably is chosen from particulate carbons such as carbon black, conducting polymers, conducting transition metal carbides, conducting metal oxide bronzes and other conducting carbons. According to a preferred embodiment, the electrically conductive component is a carbon support such as a particulate carbon or a carbon paper. Examples of suitable conducting carbons include turbostratic carbon and graphitic carbon. Any organic solvent is suitable provided that the solvent is inert to all reactants used and products formed, and mixtures of such solvents may also be utilized. One such suitable solvent is THF.

After the organometallic clusters have adsorbed on the electrically conductive component, the solvent is then removed so as to leave behind the electrically conducting component with the organometallic clusters adsorbed thereto. The solvent may be removed by vacuum drying or by other solvent removal methods know in the art.

The term “electrically conductive component” as used herein can include particulate carbons, conducting polymers such as polyaniline or polypyrrole, conducting transition metal carbides, conducting metal oxide bronzes and other conducting carbons. Preferred carbons are turbostratic or graphitic carbons of varying surface areas such as Vulcan® XC72R (available from Cabot Corp., Alpharetta, Ga.), Ketjen black® EC-600JD or EC-300J (available from Akzo Nobel Inc., Chicago, Ill.), Black Pearls® (available from Cabot Corp.), acetylene black (available as Denka® Black from Denki Kagku Kogyo Kabushiki Kaisha, Tokyo, Japan), as well as other conducting carbon varieties. Other carbons include carbon fibers, single- or multi-wall carbon nanotubes, and other carbon structures (e.g., fullerenes and nanohorns). Typically, electrically conductive components include Vulcan® XC72R and Ketjenblack® EC-600JD.

In a non-oxidizing atmosphere such as an inert gas, the clusters adsorbed onto the electrically conducting support are heat-treated by heating them to a temperature of at least 175⁰ C. It has been found that thermolysis of the clusters begins at a temperature about 100⁰ C. and then, at a temperature about 140⁰ C. the elimination of cyclic hydrocarbon ligands, namely dicyclopentadiene or cyclooctadiene takes place. Finally, at a temperature 175⁰ C., most of CO ligands are lost. When the electrically conductive component is in the form of a particulated carbon powder, the powders are heat-treated at about 200-250° C. for removing the ligands. Typically, the heat-treatment is carried out for at an hour, and preferably about 2 hours, under a protected non-oxidizing gas atmosphere of nitrogen or argon.

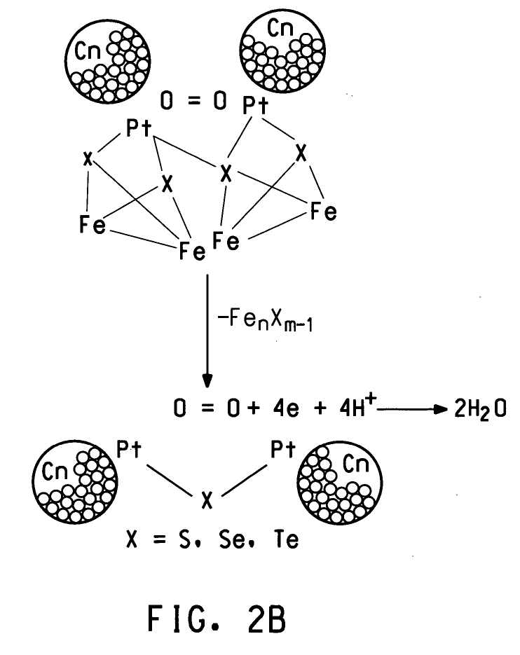

It is believed that after heat-treatment a di-facial nano-structured electrocatalyst is formed where both of the different metals M are capable of interacting with oxygen molecules to catalyze oxygen reduction, as shown in FIG. 2A. A mechanism for this catalytic oxygen reduction has been proposed, and is shown in FIG. 2B. In FIGS. 2A and 2B, Cn represents the electrically conductive component such as a carbon support. Where the electrically conductive component is particulate carbon, the catalyst material preferably comprises 10-30 wt % of the chalcogen containing group such as MₙFeₚXₘ or MₙXₘ and 70-90 wt % of particulate carbon.

The electronic conductivity of the catalysts is improved by the addition of inert conductive materials such as carbon or graphite and the heat treatment at a temperature of at least 175° C. The catalytic activity of various catalyst materials was evaluated by electrochemical measurements, including cyclic voltammetry (CV) on gas-diffusion electrodes.

In summary PtFeX and PtX systems have catalytic activity superior to Pt-black for oxygen reduction in the presence of methanol, and shows no catalytic activity towards methanol electrooxidation. Thus, the electrocatalysts of the present invention are clearly methanol tolerant, i.e., they do not interact with methanol nor are they poisoned by its presence.

Coated Substrate:

The coated substrate may comprise a catalyst coated membrane or a coated gas diffusion backing.

A variety of techniques are known for CCM manufacture which apply an electrocatalyst coating composition onto a substrate such as an ion exchange polymer membrane. Some known methods include spraying, painting, patch coating and screen printing.

Typically, the electrocatalyst coating composition comprises a catalyst, a binder such as an ion exchange polymer, and a solvent. Since the ion exchange polymer employed in the electrocatalyst coating composition serves not only as binder for the catalyst but also assists in securing the electrode to the membrane, it is preferable for the ion exchange polymers in the composition to be compatible with the ion exchange polymer in the membrane. Most typically, ion exchange polymers in the composition are the same type as the ion exchange polymer in the membrane.

Ion exchange polymers for use in accordance with the present invention are typically highly fluorinated ion-exchange polymers. “Highly fluorinated” means that at least 90% of the total number of univalent atoms in the polymer are fluorine atoms. Most typically, the polymer is perfluorinated. It is also typical for use in fuel cells for the polymers to have sulfonate ion exchange groups. The term “sulfonate ion exchange groups” is intended to refer to either sulfonic acid groups or salts of sulfonic acid groups, typically alkali metal or ammonium salts. For applications where the polymer is to be used for proton exchange as in fuel cells, the sulfonic acid form of the polymer is typical. If the polymer in the electrocatalyst coating composition is not in sulfonic acid form when used, a post treatment acid exchange step will be required to convert the polymer to acid form prior to use.

Typically, the ion exchange polymer employed comprises a polymer backbone with recurring side chains attached to the backbone with the side chains carrying the ion exchange groups. Possible polymers include homopolymers or copolymers of two or more monomers. Copolymers are typically formed from one monomer which is a nonfunctional monomer and which provides carbon atoms for the polymer backbone. A second monomer provides both carbon atoms for the polymer backbone and also contributes the side chain carrying the cation exchange group or its precursor, e.g., a sulfonyl halide group such a sulfonyl fluoride (—SO₂F), which can be subsequently hydrolyzed to a sulfonate ion exchange group. For example, copolymers of a first fluorinated vinyl monomer together with a second fluorinated vinyl monomer having a sulfonyl fluoride group (—SO₂F) can be used. Possible first monomers include tetrafluoroethylene (TFE), hexafluoropropylene, vinyl fluoride, vinylidine fluoride, trifluoroethylene, chlorotrifluoroethylene, perfluoro (alkyl vinyl ether), and mixtures thereof. Possible second monomers include a variety of fluorinated vinyl ethers with sulfonate ion exchange groups or precursor groups which can provide the desired side chain in the polymer. The first monomer may also have a side chain which does not interfere with the ion exchange function of the sulfonate ion exchange group. Additional monomers can also be incorporated into these polymers if desired.

Typical polymers include a highly fluorinated, most typically a perfluorinated, carbon backbone with a side chain represented by the formula —(O—CF₂CFR_{f})ₐ—O—CF₂CFR′_{f}SO₃H, wherein R_{f} and R′_{f} are independently selected from F, Cl or a perfluorinated alkyl group having 1 to 10 carbon atoms, a=0, 1 or 2. The typical polymers include, for example, polymers disclosed in U.S. Pat. No. 3,282,875 and in U.S. Pat. Nos. 4,358,545 and 4,940,525. One typical polymer comprises a perfluorocarbon backbone and the side chain is represented by the formula —O—CF₂CF(CF₃)—O—CF₂CF₂SO₃H. Polymers of this type are disclosed in U.S. Pat. No. 3,282,875 and can be made by copolymerization of tetrafluoroethylene (TFE) and the perfluorinated vinyl ether CF₂═CF—O—CF₂CF(CF₃)—O—CF₂CF₂SO₂F, perfluoro(3,6-dioxa-4-methyl-7-octenesulfonyl fluoride) (PDMOF), followed by conversion to sulfonate groups by hydrolysis of the sulfonyl fluoride groups and ion exchanging to convert to the acid, also known as the proton form. One typical polymer of the type disclosed in U.S. Pat. Nos. 4,358,545 and 4,940,525 has the side chain —O—CF₂CF₂SO₃H. This polymer can be made by copolymerization of tetrafluoroethylene (TFE) and the perfluorinated vinyl ether CF₂═CF—O—CF₂CF₂SO₂F, perfluoro(3-oxa-4-pentenesulfonyl fluoride) (POPF), followed by hydrolysis and acid exchange.

For perfluorinated polymers of the type described above, the ion exchange capacity of a polymer can be expressed in terms of ion exchange ratio (“IXR”). Ion exchange ratio is defined as number of carbon atoms in the polymer backbone in relation to the ion exchange groups. A wide range of IXR values for the polymer are possible. Typically, however, the IXR range for perfluorinated sulfonate polymer is usually about 7 to about 33. For perfluorinated polymers of the type described above, the cation exchange capacity of a polymer is often expressed in terms of equivalent weight (EW). For the purposes of this application, equivalent weight (EW) is defined to be the weight of the polymer in acid form required to neutralize one equivalent of NaOH. In the case of a sulfonate polymer where the polymer comprises a perfluorocarbon backbone and the side chain is —O—CF₂—CF(CF₃)—O—CF₂—CF₂-SO₃H (or a salt thereof), the equivalent weight range which corresponds to an IXR of about 7 to about 33 is about 700 EW to about 2000 EW. A preferred range for IXR for this polymer is about 8 to about 23 (750 to 1500 EW), most preferably about 9 to about 15 (800 to 1100 EW).

The liquid medium for the electrocatalyst coating composition is one selected to be compatible with the process. It is advantageous for the medium to have a sufficiently low boiling point that rapid drying of electrode layers is possible under the process conditions employed, provided however, that the composition cannot dry so fast that the composition dries on the substrate before transfer to the membrane. When flammable constituents are to be employed, the selection should take into consideration any process risks associated with such materials, especially since they will be in contact with the catalyst in use. The medium should also be sufficiently stable in the presence of the ion exchange polymer that, in the acid form, has strong acidic activity. The liquid medium typically will be polar since it should be compatible with the ion exchange polymer in the electrocatalyst coating composition and be able to “wet” the membrane. While it is possible for water to be used as the liquid medium, it is preferable for the medium to be selected such that the ion exchange polymer in the composition is “coalesced” upon drying and not require post treatment steps such as heating to form a stable electrode layer.

A wide variety of polar organic liquids or mixtures thereof can serve as suitable liquid media for the electrocatalyst coating composition. Water in minor quantity may be present in the medium if it does not interfere with the coating process. Some typical polar organic liquids have the capability to swell the membrane in large quantity although the amount of liquids the electrocatalyst coating composition applied in accordance with the invention is sufficiently limited that the adverse effects from swelling during the process are minor or undetectable. It is believed that solvents with the capability to swell the ion exchange membrane can provide better contact and more secure application of the electrode to the membrane. A variety of alcohols are well suited for use as the liquid medium.

Typical liquid media include suitable C₄ to C₈ alkyl alcohols such as n-, iso-, sec- and tert-butyl alcohols; the isomeric 5-carbon alcohols such as 1,2- and 3-pentanol, 2-methyl-1-butanol, 3-methyl, 1-butanol, etc.; the isomeric 6-carbon alcohols, such as 1-, 2-, and 3-hexanol, 2-methyl-1-pentanol, 3-methyl-1-pentanol, 2-methyl-1-pentanol, 3-methyl, 1-pentanol, 4-methyl-1-pentanol, etc.; the isomeric C₇ alcohols and the isomeric C₈ alcohols. Cyclic alcohols are also suitable. Preferred alcohols are n-butanol and n-hexanol. Most preferred is n-hexanol.

The amount of liquid medium in the electrocatalyst coating composition will vary with the type of medium employed, the constituents of the composition, the type of coating equipment employed, desired electrode thickness, process speeds etc. The amount of liquid employed is highly dependent on viscosity of the electrocatalyst coating composition that is very important to achieve high quality electrodes with a minimum of waste.

Handling properties of the electrocatalyst coating composition, e.g. drying performance, can be modified by the inclusion of compatible additives such as ethylene glycol or glycerin up to 25% by weight based on the total weight of liquid medium.

It has been found that the commercially available dispersion of the acid form of the perfluorinated sulfonic acid polymer, sold by E.I. du Pont de Nemours and Company under the trademark Nafion®, in a water/alcohol dispersion, may be used as starting material to prepare the electrocatalyst coating composition. Using this ion exchange polymer containing dispersion as base for the electrocatalyst coating composition, the catalyst of the invention required to form an electrode can be added which yields a coating composition with excellent application properties.

In the electrocatalyst coating composition, it is preferable to adjust the amounts of catalyst, ion exchange polymer and other components, if present, so that the catalyst is the major component by weight of the resulting electrode. Most preferably, the weight ratio of catalyst to ion exchange polymer in the electrode is about 2:1 to about 10:1.

Utilization of the known electrocatalyst coating techniques may produce a wide variety of applied layers which can be of essentially any thickness ranging from very thick, e.g., 20 μm or more very thin, e.g., 1 μm or less.

The substrate for use in preparing a catalyst-coated membrane (CCM) may be a membrane of the same ion exchange polymers discussed above for use in the electrocatalyst coating compositions. The membranes may typically be made by known extrusion or casting techniques, and have a thickness which may vary depending upon the application, and typically have a thickness of 350 μm or less. The trend is to employ membranes that are quite thin, i.e., 50 μm or less. While the polymer may be in alkali metal or ammonium salt form, it is typical for the polymer in the membrane to be in acid form to avoid post treatment acid exchange steps. Suitable perfluorinated sulfonic acid polymer membranes in acid form are available under the trademark Nafion® by E.I. du Pont de Nemours and Company.

Reinforced perfluorinated ion exchange polymer membranes can also be utilized in CCM manufacture. Reinforced membranes may be made by impregnating porous, expanded PTFE (ePTFE) with ion exchange polymer. ePTFE is available under the tradename “Goretex” from W. L. Gore and Associates, Inc., Elkton Md., and under the tradename “Tetratex” from Tetratec, Feasterville Pa. Impregnation of ePTFE with perfluorinated sulfonic acid polymer is disclosed in U.S. Pat. Nos. 5,547,551 and 6,110,333.

Alternately, the ion exchange membrane may be a porous support for the purposes of improving mechanical properties, for decreasing cost and/or other reasons. The porous support may be made from a wide range of components, for e.g., hydrocarbons such as a polyolefin, e.g., polyethylene, polypropylene, polybutylene, copolymers of those materials, and the like. Perhalogenated polymers such as polychlorotrifluoroethylene may also be used. The membrane may also be made from a polybenzimadazole polymer. This membrane may be made by casting a solution of polybenzimadazole in phosphoric acid (H₃PO₄) doped with trifluoroacetic acid (TFA) as described in U.S. Pat. Nos. 5,525,436; 5,716,727, 6,025,085 and 6,099,988.

Where the coated substrate is a gas diffusion backing, the gas diffusion backing may comprise a porous, conductive sheet material such as paper or cloth, made from a woven or non-woven carbon fiber, that is treated to exhibit hydrophilic or hydrophobic behavior, and a gas diffusion layer, typically comprising a film of carbon particles and fluoropolymers such as PTFE. The electrocatalyst coating composition is coated thereon. The electrocatalyst coating composition which forms the anode or cathode is the same as that described earlier for the catalyst coated membrane.

Fuel Cell

The fuel cell of the invention comprises a coated substrate, wherein the coated substrate comprises a substrate having coated thereon an electrocatalyst coating composition, wherein the electrocatalyst coating composition comprises a product obtained by mixing together: (1) organometallic clusters containing (i) a carbonyl group or a cyclic unsaturated hydrocarbon ligand group, and (ii) a chalcogen containing group selected from MₙFeₚXₘ, MₙXₘ, MₙClₚXₘ, or mixtures thereof wherein M=Pt, Ru or Re, X=S, Se or Te, and m, n and p=1 or 2, (2) an electrically conductive component, and (3) an organic solvent, such that the clusters are adsorbed on the electrically conductive component; subsequently removing the solvent; and in a non-oxidizing atmosphere, heat-treating of the clusters adsorbed on the electrically conductive component at a temperature of at least 175° C. The coated substrate may be a catalyst coated membrane or a coated gas diffusion backing.

Catalysts in the anode and the cathode typically induce the desired electrochemical reactions. The fuel cells typically also comprise a porous, electrically conductive sheet material that is in electrical contact with each of the electrodes, and permit diffusion of the reactants to the electrodes. As described earlier, the electrocatalyst coating compositions may be coated on, an ion exchange membrane, to form an anode or cathode thereon, thereby forming a catalyst coated membrane. Alternatively, the electrocatalyst coating composition may be coated on a porous, conductive sheet material, typically known as a gas diffusion backing. The gas diffusion backings are normally made of woven or non-woven carbon fiber substrates which are treated to affect the water wettability properties. The gas diffusion backing substrate may be coated on one or both surfaces with a thin porous layer containing carbon particles and a binder (usually PTFE), this layer is usually referred to as the “gas diffusion layer”. The electrocatalyst coating composition may be coated on to the gas diffusion layer.

When the electrocatalyst coating composition described above is employed as the cathode electrode in a direct methanol fuel cell, the cathode is useful for oxygen reduction while at the same time being methanol “tolerant”. Being “tolerant” to methanol means that the catalyst in the cathode does not oxidize methanol and, subsequently, the cathode electrode and the membrane are not poisoned by methanol or any of its oxidation products such as CO. Methanol transported to the cathode does not participate in any chemical or electrochemical reaction. Moreover, the electrocatalyst coating composition described above has excellent oxygen reduction catalytic activity.

An assembly including the membrane, and gas diffusion backings with the electrocatalyst composition coated either on the membrane or the gas diffusion backings or on both, is sometimes referred to as a membrane electrode assembly (“MEA”). Bipolar separator plates, made of a conductive material and providing flow fields for the reactants, are placed between a number of adjacent MEAs. A number of MEAs and bipolar plates are assembled in this manner to provide a fuel cell stack.

For the electrodes to function effectively in these types of fuel cells, effective catalyst sites must be provided. Effective catalyst sites have several desirable characteristics: (1) the sites are accessible to the reactant, (2) the sites are electrically connected to the gas diffusion layer, and (3) the sites are ionically connected to the fuel cell electrolyte.

It is desirable to seal reactant fluid stream passages in a fuel cell stack to prevent leaks or inter-mixing of the fuel and oxidant fluid streams. Fuel cell stacks typically employ fluid tight resilient seals, such as elastomeric gaskets between the separator plates and membranes. Such seals typically circumscribe the manifolds and the electrochemically active area. Sealing is achieved by applying a compressive force to the resilient gasket seals.

Fuel cell stacks are compressed to enhance sealing and electrical contact between the surfaces of the separator plates and the MEAs, and sealing between adjacent fuel cell stack components. In conventional fuel cell stacks, the fuel cell stacks are typically compressed and maintained in their assembled state between a pair of end plates by one or more metal tie rods or tension members. The tie rods typically extend through holes formed in the stack end plates, and have associated nuts or other fastening means to secure them in the stack assembly. The tie rods may be external, that is, not extending through the fuel cell plates and MEAs, however, external tie rods can add significantly to the stack weight and volume. It is generally preferable to use one or more internal tie rods that extend between the stack end plates through openings in the fuel cell plates and MEAs as described in U.S. Pat. No. 5,484,666. Typically resilient members are utilized to cooperate with the tie rods and end plates to urge the two end plates towards each other to compress the fuel cell stack.

The resilient members accommodate changes in stack length caused by, for example, thermal or pressure induced expansion and contraction, and/or deformation. That is, the resilient member expands to maintain a compressive load on the fuel cell assemblies if the thickness of the fuel cell assemblies shrinks. The resilient member may also compress to accommodate increases in the thickness of the fuel cell assemblies. Preferably, the resilient member is selected to provide a substantially uniform compressive force to the fuel cell assemblies, within anticipated expansion and contraction limits for an operating fuel cell. The resilient member may comprise mechanical springs, or a hydraulic or pneumatic piston, or spring plates, or pressure pads, or other resilient compressive devices or mechanisms. For example, one or more spring plates may be layered in the stack. The resilient member cooperates with the tension member to urge the end plates toward each other, thereby applying a compressive load to the fuel cell assemblies and a tensile load to the tension member.

The present invention will now be described below in greater detail by way of Examples, which serve to illustrate the preparation and testing of illustrative embodiments of the present invention.

### EXAMPLE 1

A. Synthesis of dicyclopentadienyl-ethoxide-platinum dithizone Complex [(EtOC₁₀H₁₂)Pt(C₁₃N₄S)]

A dark blue-green solution of 0.25 g (1 mmol) of dithizone, C₁₃H₁₂N₄S, in 25 ml of CH₂Cl₂ was added to a red-brown solution of 0.40 g (0.5 mmol) of [(EtOC₁₀H₁₂)PtOEt]₂ in 15 ml of CH₂Cl₂. The solution immediately turned dark crimson. It was concentrated to dryness in vacuum, and the solid residue was extracted with 60 ml of diethyl ether; the volume of the solution was reduced to 5 ml, then it was kept at −10° C. The formed plate like dark red crystals were dried in air to give 0.32 g (0.46 mmol) of etherate. Yield, 46%. For C₂₉H₃₈O₂SN₄Pt Calc. (%): C, 49.64; H, 5.90; S, 4.56; N, 7.99. Found (%): C, 49.56; H, 5.75; S, 4.90; N, 8.02.

B. Preparation of Catalyst from (C₁₃H₁₂N₄S)Pt(C₁₀H₁₂Et) on Ketjen Black

To the mixture of 55.3 mg of (C₁₃H₁₂N₄S)Pt(C₁₀H₁₂Et) and 40.6 mg Ketjen Black, 15 ml of THF were added, and then the mixture was dried in vacuum and the solid was heated at 350° C. for 45 min (under Ar).

Found: S, 1.4; N, 0.7%.

(C₁₀H₁₂OEt)Pt(C₆H₅NHN═CS N═NC₆H₅)₉+Kejten Black→250° C. 1 hour, 350° C., 30 min

EDAX and XPS

Pt:S:N=8.5:1:0.6

C. Catalyst Coated Membrane Preparation Procedure

The cathode catalyst dispersion was prepared in an Eiger® bead mill, (manufactured by Eiger Machinery Inc., Greylake, Ill. 60030), containing 80 ml 1.0-1.25 zirconia grinding media. 1 grams of new catalyst and appropriate amount of the 3.5 wt % Nafion® solution (the polymer resin used in such a solution was typically of 930 EW polymer and was in the sulfonyl fluoride form) were mixed and charged into the mill and dispersed for 2 hours. Material was withdrawn from the mill and particle size measured. The ink was tested to ensure that the particle size was under 1 micron and the % solids in the range of 13.56-13.8. The catalyst decal was prepared by drawing down the catalyst ink to a dimension of 5 cm×5 cm (to give a total area of 25 cm²) on a 10 cm×10 cm piece of 3 mil thick Kapton® polyimide film (manufactured by E.I. duPont de Nemours and Company, Wilmington, Del.). The wet coating thickness was adjusted to achieve a catalyst loading of 0.5 mgPt/cm² in the final CCM.

Anode decals were prepared using a procedure similar to that described above, except that in the catalyst dispersion, the platinum catalyst was replaced by PtRu black catalyst.

The CCM was prepared by a decal transfer method. A piece of wet Nafion® N117 membrane (4″×4″) in the H+ form was used for CCM preparation. The membrane was sandwiched between two anode and cathode catalyst coated decals. Care was taken to ensure that the coatings on the two decals were registered with each other and were positioned facing the membrane. The entire assembly was introduced between two preheated (to 145° C.) 8″×8″ plates of a hydraulic press and the plates of the press were brought together without wasting much time until a pressure of 5000 lbs was reached. The sandwich assembly was kept under pressure for approximately 2 minutes and then the press was cooled for approximately 2 minutes (viz. till it reached a temperature of <60° C.) under the same pressure. Then the assembly was removed from the press and the Kapton® films were slowly peeled off from the top of the membrane showing that the catalyst coating had been transferred to the membrane. The CCM was immersed in a tray of water (to ensure that the membrane was completely wet) and carefully transferred to a zipper bag for storage and future use.

D. Chemical Treatment of CCM's

The CCM's were chemically treated in order to convert the ionomer in the catalyst layer from the SO₂F form to the H+ form. This required a hydrolysis treatment followed by an acid exchange procedure. The hydrolysis of the CCM's was carried out in a 30-wt % NaOH solution at 80° C. for 30 minutes. The CCM's were placed between Teflon® mesh, (manufactured by E.I. DuPont de Nemours and Company, Wilmington, Del.), and placed in the solution. The solution was stirred to assure uniform hydrolysis. After 30 minutes in the bath, the CCM's were removed and rinsed completely with fresh deionized water to remove all the NaOH.

Acid exchange of the CCM's that were hydrolyzed in the previous step was done in 15-wt % nitric acid solution at a bath temperature of 65° C. for 45 minutes. The solution was stirred to assure uniform acid exchange. This procedure was repeated in a second bath containing 15-wt % nitric acid solution at 65° C. and for 45 minutes.

The CCM's were then rinsed in flowing deionized water for 15 minutes at room temperature to ensure removal of all the residual acid. They were then packaged wet and labeled. The CCM comprised a Nafion® perflourinated ion exchange membrane; and electrodes, prepared from a platinum catalyst and Nafion® binder on the cathode and a platinum/ruthenium catalyst and Nafion® binder on the anode side.

E. Fuel Cell Performance Evaluation Procedure

Fuel cell test measurements were made employing a single cell test assembly obtained from Fuel Cell Technologies Inc, New Mexico. The MEA comprised the CCM sandwiched between two sheets of the GDB (taking care to ensure that the GDB covered the catalyst coated area on the CCM). The anode gas diffusion backing comprised carbon paper. The cathode diffusion backing comprised a carbon cloth substrate with a single microporous layer (ELAT), from E-Tek Inc., Natick, Mass. The microporous layer was disposed toward the cathode catalyst. A glass fiber reinforced silicone rubber gasket (Furan®—Type 1007, obtained from Stockwell Rubber Company), cut to shape to cover the exposed area of the membrane of the CCM, was placed on either side of the CCM/GDB assembly (taking care to avoid overlapping of the GDB and the gasket material). The entire sandwich assembly was assembled between the anode and cathode flow field graphite plates of a 25-cm² standard single cell assembly (obtained from Fuel Cell Technologies Inc., Los Alamos, N. Mex.). The test assembly was also equipped with anode inlet, anode outlet, cathode gas inlet, cathode gas outlet, aluminum end blocks, tied together with tie rods, electrically insulating layer and the gold plated current collectors. The bolts on the outer plates of the single cell assembly were tightened with a torque wrench to a force of 1.5 ft.lbs.

The single cell assembly was then connected to the fuel cell test station. The components in a test station include a supply of air for use as cathode gas; a load box to regulate the power output from the fuel cell; a MeOH solution tank to hold the feed anolyte solution; a heater to pre-heat the MeOH solution before it entered the fuel cell; a liquid pump to feed the anolyte solution to the fuel cell at the desired flow rate; a condenser to cool the anolyte exiting from the cell from the cell temperature to room temperature and a collection bottle to collect the spent anolyte solution.

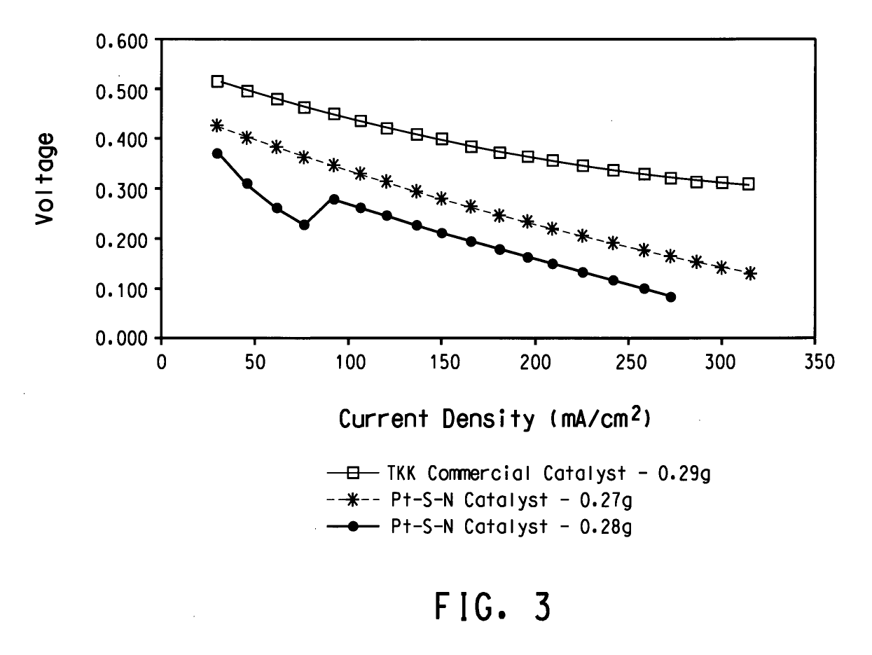

With the cell at room temperature, 1 M MeOH solution and air were introduced into the anode and cathode compartments through inlets of the cell. The flow rates were adjusted to maintain a constant methanol stoich of 4× at anode and of 3× at the cathode respectively. The temperature of the single cell was slowly raised until it reached 70° C. Typically, a current-voltage polarization curve was recorded. This comprised of recording the voltage output from the cell as the current was stepped up. The current was held constant in each step for 8 minutes to allow for the voltage output from the cell to stabilize. Typical polarization curve is shown in FIG. 3.

What is claimed is:

1. A coated substrate comprising a substrate with a catalyst coating composition thereon, wherein the catalyst coating composition comprises the product obtained by
(a) mixing together:
(1) organometallic clusters containing (i) a carbonyl group or a cyclic unsaturated hydrocarbon ligand group, and (ii) a chalcogen containing group selected from MₙFeₚXₘ, MₙXₘ, MₙClₚXₘ, or mixtures thereof wherein M=Pt, Ru or Re, X=S, Se or Te, and m, n and p=1 or 2,
(2) an electrically conductive component, and
(3) an organic solvent, such that the clusters are adsorbed on the electrically conductive component;
(b) subsequently removing the solvent; and
(c) in a non-oxidizing atmosphere, heat-treating the clusters adsorbed on the electrically conductive component at a temperature of at least 175° C.

2. The coated substrate of claim 1, wherein the substrate is chosen from an ion exchange membrane and a gas diffusion backing.

3. The coated substrate of claim 2 wherein the ion exchange membrane is the acid form of a perfluorinated sulfonic acid polymer.

4. The coated substrate of claim 2 wherein the gas diffusion backing is a porous, conductive sheet material and a gas diffusion layer.

5. The coated substrate of claim 4 wherein the porous, conductive sheet material is paper or cloth, made from a woven or non-woven carbon fiber, that is treated to exhibit hydrophilic or hydrophobic behavior.

6. The coated substrate of claim 4 wherein gas diffusion layer is a film of carbon particles and fluoropolymers.

7. The coated substrate of claim 1 wherein the catalyst coating composition further comprises a binder.

8. The coated substrate of claim 7 wherein the binder is an ion exchange polymer.

9. The coated substrate of claim 7 wherein the catalyst coating composition further comprises a solvent.

10. The coated substrate of claim 3 wherein ion exchange membrane has a cathode electrode adhered thereto, said cathode electrode being formed from an application of the catalyst coating composition to the ion exchange membrane.

11. The coated substrate of claim 1 wherein the electrically conductive component is selected from particulate carbons, conducting polymers, conducting transition metal carbides, conducting metal oxide bronzes and other conducting carbons.

12. The coated substrate of claim 1 wherein the electrically conductive component is a carbon support.

13. The coated substrate of claim 12 wherein the carbon support is particulate carbon.

14. The coated substrate of claim 11 wherein the electrically conductive component is a turbostratic or graphitic carbon.

15. The coated substrate of claim 1 wherein the clusters adsorbed on the electrically conductive component are heat-treated at about 200-250° C. for about 1 to 2 hours.

16. The coated substrate of claim 13 wherein the chalcogen containing group comprises Pt, Fe and an element selected from S, Se and Te.

17. The coated substrate of claim 13 wherein the chalcogen containing group comprises Ru, Fe and S.

18. The coated substrate of claim 13 wherein the chalcogen containing group comprises Re, Fe and S.

19. The coated substrate of claim 13, wherein the chalcogenide is MₙFeₚXₘ and the catalyst material comprises 10-30 wt % of MₙFeₚXₘ and 70-90 wt % of particulate carbon.

20. The coated substrate of claim 13 wherein the chalcogen containing group comprises Pt and S.

21. The coated substrate of claim 20 wherein Pt and S are present in the atomic ratio Pt: S=2:1.

22. The coated substrate of claim 13 wherein the chalcogen containing group comprises Pt and TE.

23. The coated substrate of claim 22 wherein Pt and Te are present in the atomic ratio Pt: Te=2:1.

24. The coated substrate of claim 13 wherein the chalcogen containing group is MₙXₘ and the clusters adsorbed on particulate carbon are heat-treated at about 250° C. for at least 1 hour.

25. The coated substrate of claim 13, wherein the chalcogenide is MₙXₘ and the catalyst material comprises 10-30 wt % of MₙXₘ and 70-90 wt % of particulate carbon.

26. The coated substrate of claim 12 wherein the organometallic clusters adsorbed on a carbon support are heat-treated in an atmosphere of inert gas.

27. A coated substrate comprising a substrate with a methanol tolerant electrocatalyst coating composition thereon, wherein the electrocatalyst coating composition comprises a heat-treated chalcogenide adsorbed onto an electrically conductive component, said chalcogenide being from the group of MₙFeₚXₘ, MₙXₘ, MₙClₚXₘ, or mixtures thereof wherein M=Pt, Ru or Re, X=S, Se or Te, and m, n and p=1 or 2.

28. A coated substrate of claim 27 wherein the elctrocatalyst of the electrocatalyst coating composition comprises a di-facial nano-structured configuration.

29. A fuel cell comprising a coated substrate, wherein the coated substrate comprises a substrate having coated thereon a catalyst coating composition, wherein the catalyst coating composition comprises the product obtained by
(a) mixing together:
(1) organometallic clusters containing (i) a carbonyl group or a cyclic unsaturated hydrocarbon ligand group, and (ii) a chalcogen containing group selected from MₙFeₚXₘ, MₙXₘ, MₙClₚXₘ, or mixtures thereof wherein M=Pt, Ru or Re, X=S, Se or Te, and m, n and p=1 or 2,
(2) an electrically conductive component, and
(3) an organic solvent, such that the clusters are adsorbed on the electrically conductive component;
(b) subsequently removing the solvent; and
(c) in a non-oxidizing atmosphere, heat-treating the clusters adsorbed on the electrically conductive component at a temperature of at least 175° C.

30. The fuel cell of claim 29 wherein the substrate is an ion exchange membrane.

31. The fuel cell of claim 30 wherein the ion exchange membrane is the acid form of the perfluorinated sulfonic acid polymer.

32. The fuel cell of claim 30 wherein the fuel cell further comprises an anode electrode and a cathode electrode on opposite sides of the ion exchange membrane and the catalyst coating composition is part of the cathode electrode.

33. The fuel cell of claim 29 wherein the substrate is a gas diffusion backing.

34. The fuel cell of claim 33 wherein the fuel cell further comprises an anode electrode and a cathode electrode on opposite sides of the ion exchange membrane and the catalyst coating composition is part of the cathode electrode.

35. A method for producing a substrate coated with an electrocatalyst coating composition, comprising the steps of
(a) mixing together:
(1) organometallic clusters containing (i) a carbonyl group or a cyclic unsaturated hydrocarbon ligand group, and (ii) a chalcogen containing group selected from MₙFeₚXₘ, MₙXₘ, MₙClₚXₘ, or mixtures of MₙFeₚXₘ, MₙXₘ, and MₙClₚXₘ wherein M=Pt, Ru or Re, X=S, Se or Te, and m, n and p=1 or 2,
(2) an electrically conductive component, and
(3) an organic solvent, such that the clusters are adsorbed on the electrically conductive component;
(b) removing the solvent;
(c) in a non-oxidizing atmosphere, heat-treating of the clusters adsorbed on the electrically conductive component at a temperature of at least 175° C.;
(d) mixing the heat-treated clusters adsorbed on the electrically conductive component with a binder to form an electrocatalyst coating composition, and
(e) applying the electrocatalyst coating composition to the substrate.
